(19) United States
(12) Patent Application Publication
(10) Pub. No.: US 2017/0330544 A1
(43) Pub. Date: Nov. 16, 2017

(54) METHOD AND SYSTEM FOR CREATING AN AUDIO COMPOSITION

(71) Applicant: FILMSTRO LIMITED, Lewes, Sussex (GB)

(72) Inventors: Sebastian JAEGER, Lewes, Sussex (GB); Christopher Stephen YOUNG, Wafers, Worcestershire (GB)

(21) Appl. No.: 15/533,206

(22) PCT Filed: Nov. 10, 2015
(86) PCT No.: PCT/GB2015/053406

§ 371 Date: Jun. 5, 2017

(30) Foreign Application Priority Data
Dec. 3, 2014 (GB) 1421513.1

(51) Int. Cl. G10H 1/46; G06F 3/01; G06K 9/00; G10H 1/00

(52) U.S. Cl. CPC G10H 1/46; G10H 1/0066; G06F 3/017; G06K 9/00362; G10H 2250/311

(57) ABSTRACT

The present disclosure relates to a method for determining a respective stem volume for each respective stem of an audio composition including a plurality of stems. A first value for each of one or more parameters is received for a first segment of the audio composition. For each respective stem of the audio composition, a first respective stem volume is determined for the first segment of the audio composition based on the one or more parameters and a volume control layer.

### TECHNICAL FIELD

The present invention is in the field of audio editing. More particularly, but not exclusively, the present invention relates to audio mixing.

### BACKGROUND

Creating soundtracks, or custom audio compositions, has traditionally required specialized tools and expertise. Not only must soundtracks be composed and performed by musicians, they also must be synced to the events of a video timeline. For amateur film makers, and hobbyists in particular, generating high quality custom audio compositions has been inaccessible.

Typically, custom audio compositions are created via a sound mixing process. The sound mixing process may include taking a number of component, individual stem audio files, and combining them to create the custom audio composition. Stems are also sometimes referred to as submixes, subgroups, or busses. Stems may include any combination of dialogue, music, or sound effects. Music stems may include single instruments, sections of instruments, instruments playing specific types of music, or different styles of playing. Stem-mixing may include creating and processing stems separately prior to combining them into the final custom audio composition.

At some point in the film or video making process, audio is combined with video. An audio composition may be created to correspond with video events, to create a desired narrative or emotional response, or to be played on different sound systems or different theatres. Sound engineers are able to address these needs and create high-quality custom audio composition by mixing stem files into a custom audio composition at different points in the video timeline.

Prior solutions have attempted to streamline the process of creating a custom audio composition for a video by providing a library of pre-mixed audio compositions. Upon selecting desirable qualities, such as mood, tempo, or genre, a pre-recorded version of a selected audio composition may be automatically selected from a library.

Other solutions have offered minimal configurability for a pre-mixed audio composition. For example, some prior solutions allow a user the ability to determine the length of an audio composition by preselecting features before rendering a final audio composition. Other prior solutions have allowed users to re-arrange sequences of music loops before rendering the final version of a custom audio composition. None of these solutions allow a user to mix a set of stems into custom composition, however.

What is needed is a simplified method for creating high quality custom audio compositions which overcomes the disadvantages of the prior art, or at least provides a useful alternative.

### BRIEF SUMMARY OF THE INVENTION

According to an aspect of the Invention there is provided a method for determining a respective stem volume for each respective stem of an audio composition including a plurality of stems, the method including:

receiving a first value for each of one or more parameters for a first segment of the audio composition; and
for each respective stem of the audio composition, determining a first respective stem volume for the first segment of the audio composition based on the one or more parameters and a volume control layer.

The method may further include the step of playing each respective stem of the audio composition at the first respective stem volume for the first segment.

The method may further include the steps of receiving a second value for each of one or more parameters for a first segment of the audio composition; and for each respective stem, determining a second respective stem volume for the first segment based upon the one or more parameters and the volume control layer.

For each respective stem of the audio composition, a first respective stem volume of the audio composition may be determined based on the one or more parameters and a volume control layer by further including filtering the volume control layer corresponding to the respective stem using the one or more parameters to identify a filtered volume control layer; and calculating the first respective stem volume for the respective stem using the one or more parameters and the filtered volume control layer.

The volume control layer may include one or more volume keys.

The first respective stem volume for the respective stem may be calculated using the one or more parameters and the filtered volume control layer further including performing a linear calculation.

The first respective stem volume for the respective stem may be calculated using the one or more parameters and the filtered volume control layer by further including performing a non-linear calculation.

The volume control layer may include a neural network.

The one or more parameters may include a momentum parameter.

The one or more parameters may include a depth parameter.

The one or more parameters may include a power parameter.

The one or more parameters may include a time stretching parameter.

The one or more parameters may include an instrument selection parameter.

Each respective stem of the set of stems may correspond to a single instrument.

The method may further include the step of calculating a duration of the first segment based on the one or more parameters.

The method may further include the step of playing a video selection.

The method may further include the steps of providing a video selection interface; and receiving a video selection from the video selection interface.

The method may further include the steps of displaying an audio composition selection interface; and receiving the audio composition selection from the audio composition selection interface.

The method may further include the step of saving the one or more parameters and a timestamp for a first segment to a parameter file.

The method may further include the step of saving a rendered audio file including each respective stem at the first stem volume for the first segment.

According to an aspect of the Invention there is provided a method for playing a video and an audio composition including a set of stems, the method including

determining a respective stem volume for a first segment of the audio composition; and
playing the video and audio composition; wherein the value for each of one or more parameters is received from a parameter file.

According to an aspect of the Invention there is provided a method for modifying an audio composition, including a plurality of stems, the method including:

determining a respective stem volume for a first segment of the audio composition, each respective stem of the audio composition being determined via a method as claimed in any one of claims 1 to 28; and
playing the audio composition selection;
wherein the value for each of one or more parameters is received from a parameter selection module.

The method may further include the step of displaying a parameter selection module, the parameter selection module indicating the values of the one or more parameters.

The parameter selection module may include a software slider operable to display the one or more first parameters.

The parameter selection module may include a software slider operable to select the one or more first parameters.

The parameter selection module may include a gesture recognition interface operable to select the one or more second parameter values.

The parameter selection module may include a biometric interface operable to select the one or more second parameter values.

According to a further aspect of the Invention there is provided an electronically readable medium configured to store an audio composition.

According to a further aspect of the Invention there is provided an electronically readable medium configured to store a parameter file.

According to a further aspect of the Invention there is provided a system configured to determine a respective stem volume for each respective stem of an audio composition including a plurality of stems.

According to a further aspect of the Invention there is provided a system configured to play a video and an audio composition including a set of stems.

According to a further aspect of the Invention there is provided a system configured to modify an audio composition.

Other aspects of the disclosure are described within the claims.

### BRIEF DESCRIPTION OF THE DRAWINGS

Embodiments of the Invention will now be described, by way of example only, with reference to the accompanying drawings in which:

FIG. 1: shows a block diagram illustrating a system in accordance with an embodiment of the invention;

FIG. 2: shows method 200 in accordance with an embodiment of the invention;

FIG. 3: shows an audio composition 300 in accordance with an embodiment of the invention;

FIG. 4: shows an audio composition 300 in accordance with an embodiment of the invention;

FIG. 5: shows a volume control layer 212 in accordance with an embodiment of the invention;

FIG. 6: shows a method 600 in accordance with an embodiment of the invention;

FIG. 7: shows a method 700 in accordance with an embodiment of the invention;

FIG. 8: shows a method 800 in accordance with an embodiment of the invention;

FIG. 9: shows a method 900 in accordance with an embodiment of the invention;

FIG. 10: shows a software slider 1000 in accordance with an embodiment of the invention;

FIG. 11: shows a parameter file 1100 in accordance with an embodiment of the invention;

FIG. 12: shows a method 1200 in accordance with an embodiment of the invention;

FIG. 13: shows a method 1300 in accordance with an embodiment of the invention;

FIG. 14: shows a user interface 1400 in accordance with an embodiment of the invention; and

FIG. 15: shows a user interface 1500 in accordance with an embodiment of the invention;

FIG. 16: shows a user interface 1600 in accordance with an embodiment of the invention.

### DETAILED DESCRIPTION OF PREFERRED EMBODIMENTS

The present invention may provide a method, system, and electronically readable medium configured to determine a respective stem volume for each respective stem of an audio composition.

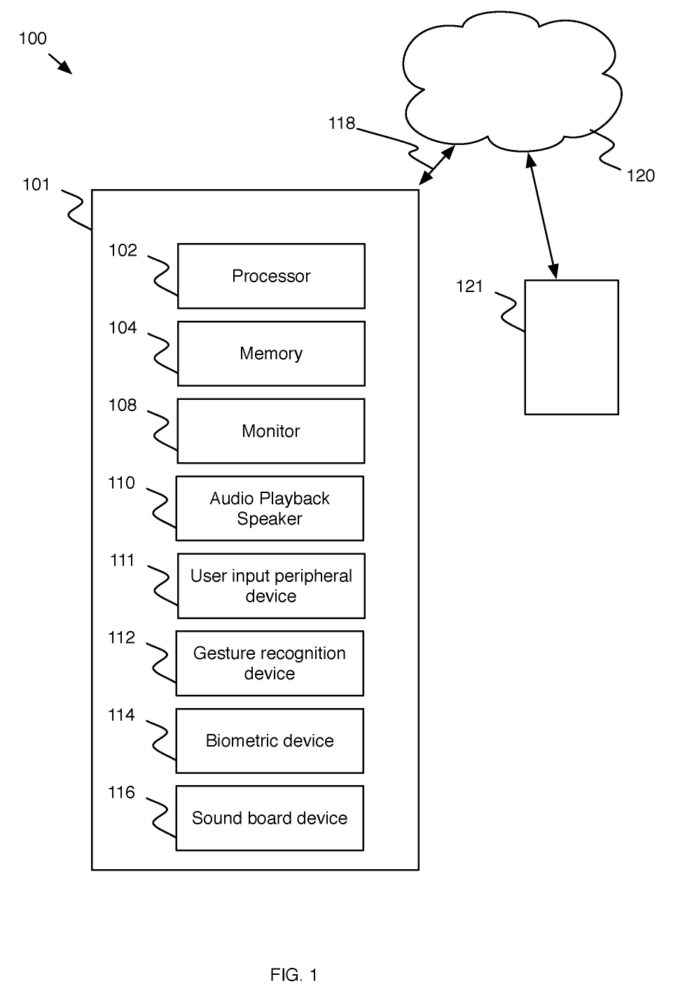

FIG. 1 depicts a system 100 in accordance with an embodiment of the invention. System 100 includes device system 101. In examples device system 101 may be a physical computing apparatus, such as a smart phone, a tablet, a laptop, or desktop computer.

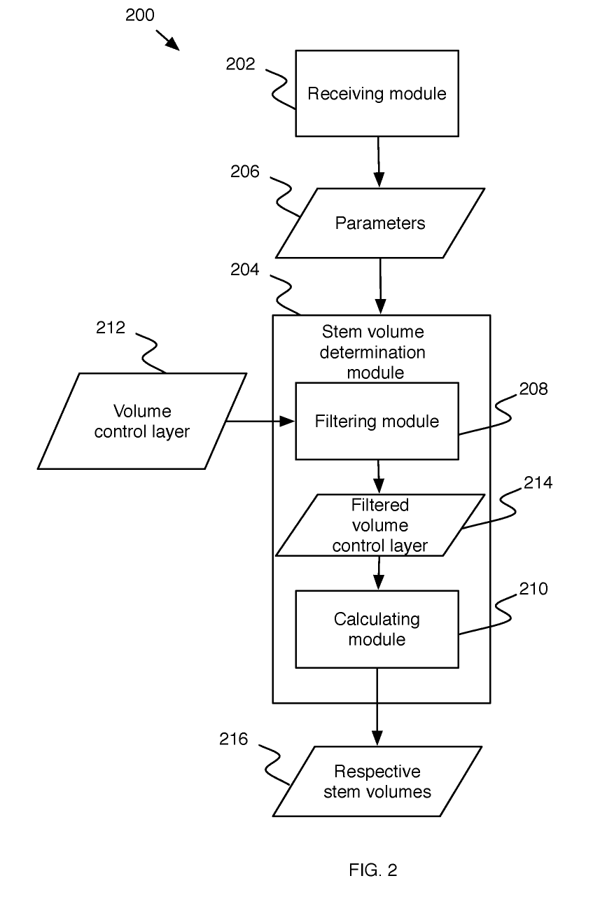

Device system 101 includes a processor 102. Processor 102 may be configured for executing computer instructions, which, when executed on the device system 101, perform a portion or all of the methods described in relation to FIGS. 2, 6, 7, 8, 9, 12, and 13. In embodiments, processor 102 may include a single, or any multiple of core processors, as will be understood by those of skill.

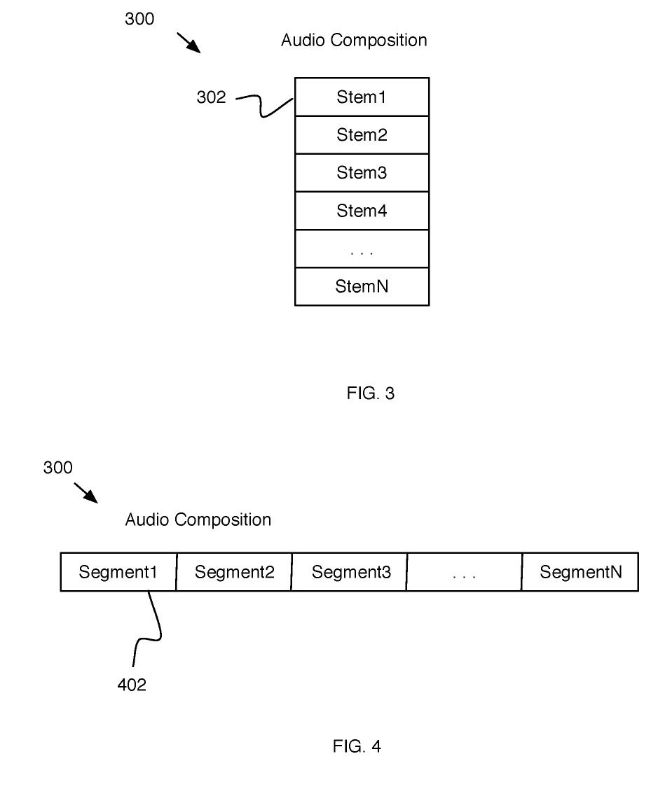

Device system 101 further includes a memory 104. Memory 104 may be configured for storing computer instructions, which, when executed on the processor 102, may perform a portion or all of the methods described in relation to FIGS. 2, 6, 7, 8, 9, 12, and 13. Memory 104 may further be configurable to store an audio composition 300, a library including audio compositions, a volume control layer 212, a video selection, a parameter file 1100, or a rendered audio file 1304, as described in relation to FIGS. 3 to 13 below.

In examples, processor 102 and memory 104 may be incorporated into a custom chipset, such as a system on a chip. For example, processor 102 and memory 104 may be incorporated into a custom Snapdragon, Tegra, Mali-400, Cortex, Samsung Exynos, Intel Atom, Apple, or Motorola chip, or any other type of chip known to those of skill in the art.

In examples, portions of the methods described in relation to FIGS. 2, 6, 7, 8, 9, 12, and 13 may be stored or executed outside of device system 101. For example, a portion of the methods described in relation to FIGS. 2, 6, 7, 8, 9, 12, and 13 may be stored or executed on a combination of a server and cloud storage facility via Internet 120, or on a further device system 121.

Device system 101 may further include a monitor 108. Monitor 108 may be operable to display video and/or a user interface in conjunction with the methods described in relation to FIGS. 2, 6, 7, 8, 9, 12, and 13.

Device system 101 may further include an audio playback speaker 110. In examples, audio playback speaker 110 may be integrated or external to device system 101. Audio playback speaker 110 may be operable to play an audio composition or a modified audio composition, as will be described below.

Device system 101 may include a user input peripheral device 111. User input peripheral device 111 may include a touch screen, mouse, trackball, touchpad, keyboard, or any other peripheral device capable of allowing the user to interact with and make selections from a user interface, providing user input to device system 101.

In examples, monitor 108 may be integrated with a touch screen. For example, monitor 108 may include a resistive, capacitive, infrared, optical, or 3D touch screen, or any other touch screen known to those of skill in the art.

Device system 101 may further include a gesture recognition device 112. For example, device system 101 may include a Microsoft Kinect, wired glove, depth-aware camera, stereo camera, radar, single camera, accelerometer, controller-based gesture interface, or any other gesture recognition device known to those of skill in the art. In examples, gesture recognition device 112 may be integrated or external to device system 101. Gesture recognition device 112 may be operable to allow a user to make parameter selections, as will be described below.

Device system 101 may further include a biometric device 114 capable of detecting a human characteristic, such as heart rate, temperature, eye movement, muscle movement, or any other type of medical or biometric information. For example, biometric device 114 may include a heart rate monitor, a thermometer, eye tracker, an electromyographic device, or any other device commonly known to those of skill in the art. Biometric device 114 may be operable to allow a user to make parameter selections, as will be described below.

Device system 101 may further include a soundboard device 116. Soundboard device 116 may include physical buttons and knobs, such as those typically found on sound boards, that may be manipulated by a user to configure one or more parameters, as described below.

Device system 101 may communicate with the Internet 120 over a communications link 118. Communications link 118 may include a wired or a wireless link using any standard commonly known to those of skill. For example, communications link 118 may include a WIFI, 3G, 4G, or an Ethernet connection. In examples, device system 101 may request, send, or receive information, save information, or send or receive messages from a remote device over Internet 120.

System 100 may include additional device system 121. Device system 121 may be similar to device system 101, and may communicate with device system 101 over Internet 120. In examples, device systems 101 and 121 may send files back to one another including parameters, audio, or video, as will be described below.

FIG. 2 depicts method 200, in accordance with embodiments of the invention. Method 200 may allow a user to determine a respective stem volume for each respective stem of an audio composition including a plurality of stems.

As depicted in FIG. 3, an audio composition 300 may include one or more individual stem files 302. Audio composition 300 may be customized to create a customized audio composition by determining a volume, and thereby a contribution, for each individual stem file 302. In embodiments, audio composition 300 may include music, dialogue, or sound effects.

Method 200 includes receiving module 202. At receiving module 202, a first value is received for each of one or more parameters for a first segment of the audio composition.

As depicted in FIG. 4 an audio composition 300 may include audio for any number of segments 402, or sequential units of time. A segment of an audio composition 300 including music may include entire music loops, or repeating sections of sound material. In further embodiments, audio composition 300 may include segments 402 of music, dialog, or sound effects segmented from a larger composition according to any arbitrarily chosen time period. In embodiments the segments of audio composition 300 may cover a similar or different time period. By determining the one or more parameters for each segment of an audio composition, it is possible to customize the audio composition along the timeline of the video.

As depicted in method 200, receiving module 202 provides parameters 206. Parameters 206 are scalable properties of an audio composition. In examples, parameters may be quantitative or qualitative properties.

In embodiments, parameters 206 may include a momentum parameter. The momentum parameter may relate to an incident frequency of an audio composition. In musical terms, for example, a change in the momentum parameter may include a change from 2 minims in a bar to 8 quavers in a bar, and this can occur as a change in instrument, but does not need to. In non-musical terms, for example, a change in momentum may include a change from a tap dripping water to a tap pouring water.

In embodiments, parameters 206 may include depth parameter. The depth parameter may relate to register changes in an audio composition, such as changing from a high register to a low register. In musical terms, a change in depth may include a change in key, a change in instrument, or a combination of the two. For example, a change in depth may signal a change from a C6 on a piano to a C1, or a change from a violin to a cello. In audio that is not musical, however, depth can relate to the register of any sound.

In embodiments, parameters 206 may include a power parameter relating to changes in sound intensity. For example, this could be changing from a flute being played to a trumpet being played, or a small drum being played to a large drum being played. In non-musical terms, this could be a change from a tap pouring water, to water falling from a waterfall.

In embodiments, parameters 206 may include a time stretching parameter. Time stretching is a process of changing the speed or duration of an audio composition without affecting its pitch. For example, the time stretching parameter may be used to create rubato effects.

In embodiments, parameters 206 may include a video volume parameter. The video volume may include video audio included with a video selection. In examples, the video audio may include a combination of dialog, sound effects, or music. The video audio may be included in a separate stem or set of stems that may be mixed into the custom audio composition along with the set of stems included in the audio composition.

In embodiments, parameters 206 may include an instrument selection parameter for the custom audio composition. An instrument selection parameter may determine whether a specific musical instrument contribution will be included in a custom audio composition. For example, an instrument selection parameter may be used to determine whether drums are included in the custom audio composition.

In embodiments, parameters 206 may include a segment duration parameter for the custom audio composition. A segment duration parameter may determine the length of a particular segment or all segments of a custom audio composition. In further examples, the length of a segment may be determined based upon a value of the one or more other parameters.

Although specific examples of parameters 206 are provided, this is not intended to be limiting. This disclosure anticipates further quantitative and qualitative parameters, as will be understood by those of skill in the art.

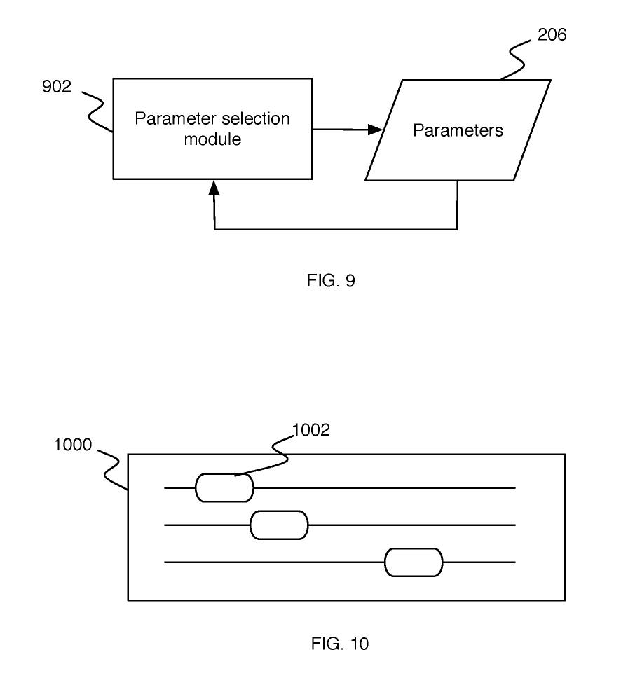

In embodiments, the first value for each of the parameters 206 may be received via the methods described with regards to FIGS. 9 to 13, as will be further explained herein.

In embodiments, each parameter 206 may be scaled to include a value between 0 and 1. In further embodiments, each parameter may be scaled to include a value between 0 and 2, or any other range of values that may optimize the operations performed in step 204, as described below.

In embodiments, a value for the one or more parameters 206 may be an ordered list of values, such as an n-tuple. For example, if the parameters include momentum, depth, and power, the value of the parameters may be expressed as the 3-tuple [0.3, 0.6, 0.1] where the momentum parameter=0.3, the depth parameter=0.6, and the power parameter=0.1.

Method 200 further includes stem volume determination module 204. In stem volume determination module 204, for each respective stem of the audio composition, a first respective stem volume for the first segment of the audio composition is determined based on the one or more parameters and a volume control layer.

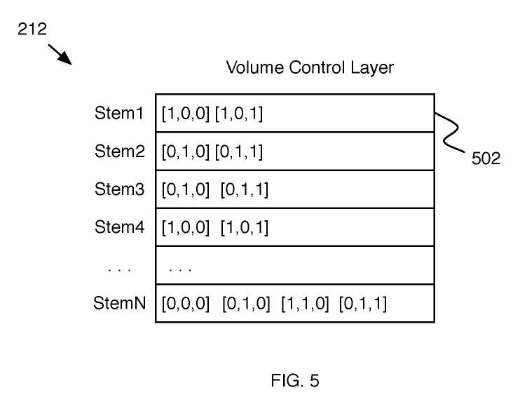

Audio composition 300 includes a set of stems 302 and a set of related data including a volume control layer 212, as depicted in FIG. 5. The volume control layer 212, when combined with the one or more parameters, is used to determine one or more stem volumes for a segment of an audio composition.

In examples, stem volume determination module 204 may further include a filtering module 208 and a calculating module 210.

Filtering module 208 may receive volume control layer 212 and provide filtered volume control layer 214.

If audio composition 300 is a musical composition including a set of stems that correspond to individual instruments, the volume control layer 212, when combined with the one or more parameters 206, may therefore help designate the contribution that each instrument provides.

An example of volume control layer 212 is provided in FIG. 5. Volume control layer 212 may include one or more respective volume control keys 502 for each stem 302 included in audio composition 300. A volume control key 502, combined with the value of parameters 206, may be used to calculate a volume setting for a respective stem 302. In examples, when a parameter value equals a volume key 502 exactly, this may correspond to a specific preset volume level.

For example, if volume control key 502 includes [1,0,0] and the value of the parameters is [1,0,0], this may correspond to a preset volume level of 100%. This is not intended to be limiting, however, in further embodiments the preset volume level may be 0%, 50%, or any other arbitrary level.

When the value of the parameters 206 does not equal volume control key 504 exactly, volume control key 504 and the value of the parameters 206 may be used to determined the respective stem volume.

Volume control layer 212 may be included with audio composition 300. For example, volume control layer 212 may be included as metadata in an audio composition file including the stem files.

Volume control key 502 may include one or more ordered lists of values, such as one or more n-tuples. In examples, the volume control keys 502 may be indexed to include the same number of elements as the parameter values 206. For a three-parameter example including momentum, depth, and power parameters, a volume key 502 may be expressed by one or more 3-tuples as follows:

VolumeKey=[momentumKey,depthKey,powerKey].

This is not intended to be limiting, however, as any order, number and combination of parameters are contemplated, as described above.

Volume keys 502 may include the same value range as the parameter values. Volume keys 502 may further have a discrete or continuous range of values. For example, if a volume key includes the discrete values for three parameters of 0 or 1, that volume key includes 8 potential tuple combinations. If a volume key includes the discrete values for three parameters of 0, 1, or 2, then that volume key includes 27 tuple combinations.

In the example volume control layer 212 provided in FIG. 5, volume key 502 corresponds to stem1. Volume control key 502 includes a value of [1,0,0] and [1,0,1], which corresponds to providing 100% volume for stem1 when the values of the momentum, depth, and power parameter are set to [1,0,0] or [1,0,1].

In filtering step 208, volume control layer 212 may be filtered using the one or more parameters 206 to identify a filtered volume control layer 214. By filtering, a criteria may be applied to volume control layer 212 to include or exclude one or more volume control keys.

In embodiments, volume control layer 212 may be filtered by calculating the differences between the value of parameters 206 and each individual volumeKey in volume control layer 212, and then applying a cut-off threshold. The following formula provides one example of how a volume key may be filtered:

filterVar=Σₙ|paramᵢ−volumeKeyᵢ|. (Equation 1)

In Equation 1, paramᵢ is an indexed parameter value and volumeKeyᵢ is an indexed volume key. If filterVar>=filterThresh, where filterThresh is a filter threshold variable, then the volume key in question may be filtered out.

For example, it is possible to filter the volume control layer as defined in Table 1 with example parameter param=[0.5,0,0] and filterThresh=1:

TABLE 1

| Stem | Instrument | Volume Control Layer |
|---|---|---|
| Stem 1 | Quick Violin | [1, 0, 0], [1, 0, 1] |
| Stem 2 | Slow Cello | [0, 1, 0], [0, 1, 1] |
| Stem 3 | Snare Drum | [0, 0, 0], [0, 1, 0], [1, 0, 0], [1, 1, 0] |
| Stem 4 | Slow Percussion | [0, 0, 0], [0, 0, 1], [0, 1, 0], [0, 1, 1] |
| Stem 5 | Fast Percussion | [1, 0, 0], [1, 0, 1], [1, 1, 0], [1, 1, 1] |
| Stem 6 | Loud Trumpet | [0, 0, 1], [1, 0, 1], [0, 1, 1], [1, 1, 1] |
| Stem 7 | Deep Horn | [0, 1, 1], [1, 1, 1] |

The first volume control key of stem 1, [1,0,0], will result in a filterVar of 0.5+0+0=0.5, which is not greater than filterThresh of 1, so the volume control key [1,0,0] will not be filtered out. The second volume control key of stem 1, [1,0,1] will result in a filterVar of 0.5+0+1=1.5, which is higher than the filterThresh of 1, and therefore will be filtered out.

Filtering example volume control layer 212 provided in Table 1 with a parameter value of [0.5, 0, 0] will result in the example filtered control layer 214 provided in Table 2.

TABLE 2

| Stem | Instrument | Filtered Volume Control Layer |
|---|---|---|
| Stem 1 | Quick Violin | [1, 0, 0] |
| Stem 2 | Slow Cello | |
| Stem 3 | Snare Drum | [0, 0, 0], [1, 0, 0] |
| Stem 4 | Slow Percussion | [0, 0, 0] |
| Stem 5 | Fast Percussion | [1, 0, 0] |
| Stem 6 | Loud Trumpet | |
| Stem 7 | Deep Horn | |

The example provided in Table 1 and Table 2 with regards to filtering a volume control layer based 212 on Equation 1 is not intended to be limiting. Other methods of comparing parameter values to a volume control layer to filter one or more volume control keys are contemplated by this disclosure.

For example, volume control layer may be filtered based on a value of a single parameter 206, such as momentum parameter.

Filtering module 208 may help quickly identify which volume control keys 502 are not close enough to the values of the parameters 206 to influence the volume of a particular stem. Filtering module 208 may further help reduce and simplify the number of computations required to determine the volumes of the stems.

In embodiments, stem volume determination module 204 may further include a calculating module 210. In calculating module 210, the first respective stem volume for each respective stem of an audio composition may be calculated using the one or more parameters 206 and the filtered volume control layer 214.

In embodiments, a respective stem volume 216 may be determined according to Equations 2, 3, and 4:

$$\begin{matrix}{stemVol}_{i} = 1 - \vert volume {Key}_{i} - {param}_{i} \vert & ( Equation 2 ) \\ Stem Key Vol = {stemVol}_{1} * stem {Vol}_{n - 1} * … * stem {Vol}_{n} & ( Equation 3 ) \\ Stem Volume = {\sum }_{n}^{1} stem Key {Vol}_{i} & ( Equation 4 )\end{matrix}$$

In Equations 2 to 4, stemVolᵢ is the stem volume calculated based on a single stem using a single parameter value and a single volume key. StemKeyVol is the stem volume based on all of the values of all of the parameters based on the single volume key. StemVolume is the total respective stem volume 216 based on all of the parameter values and volume keys included in the filtered volume control layer for the respective stem. In embodiments, respective stem volume 216 StemVolume may be capped at a value. For example, respective stem volume 216 StemVolume may be capped at 1, corresponding to a volume of 100%.

For example, for a current set of params=[0.5, 0, 0] and filtered volume control layer 214 for stem1 of [1, 0, 0], respective stem volume 216 stem Volume=0.5*1*1=0.5, or 50%. Therefore, if stem1 includes audio for a quick violin, the quick violin stem will have a 50% volume level in the custom audio composition.

In further embodiments, the filtering and calculating modules 208 and 210 may be combined into a single module. For example, Equation 5 provides a combined filtering and calculation step that may replace Equations 2 and 3:

stemVolᵢ=1−MAX(0,1−|volumeKeyᵢ−paramᵢ) (Equation 5)

In Equation 5, MAX is a function that returns a maximum value or the greater of 0 or 1 minus the absolute value of volumeKeyᵢ−paramᵢ. Equation 5 simultaneously caps the value of respective stem volume 216 stemVol and scales it to correspond to a volume level between 0 and 1.

For example, if a current set of params=[0.5, 0, 0] and volume control layer 212 for stem1 includes the volume control keys [1, 0, 0] and [1,0,1], stemKeyVol₁=0.5*1*1=0.5, and stemKeyVol₂=0.5*1*0=0. Respective stem volume 216 Stem Volume=0.5+0=0.5, or 50%. It may therefore be seen that the same result is achieved using Equations 2-4 with filtered volume control layer 214, or Equations 4 and 5 and volume control layer 212.

In examples, calculation module 210 may include a linear calculation, such as the example of Equations 2 to 5 provided above. In further examples, however, the calculation module 210 may include a non-linear calculation. For example, the calculation may provide for respective stem volumes 216 that increase more rapidly or less rapidly as a parameter value approaches a volume control key value, as will be understood by those of skill in the art.

In examples, stem volume determination module 204 may utilize one or more lookup tables indexed by the values of parameters 206 and populated with respective stem volume 216 values. In such an instance, the lookup tables may be used in place of the calculation step, or in place of both the filtering and calculation steps.

In examples, stem volume determination module 204 may include the use of a neural network. For example, respective stem volumes 216 for an audio composition may be determined using a multi-layer feed-forward neural network that has been trained using back-propagation. Other types of neural networks are also possible, as will be understood by those of skill in the art.

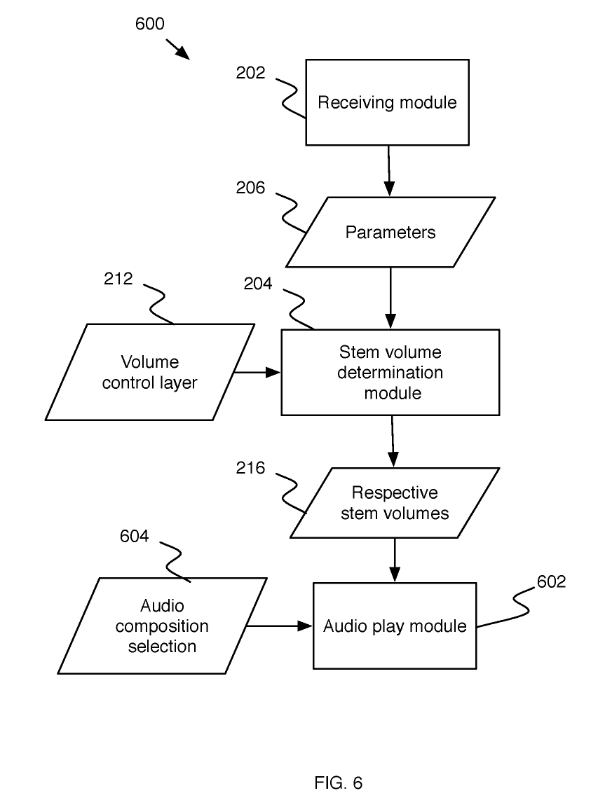

In embodiments, method 200 may include further steps. For example, FIG. 6 depicts method 600. Method 600 may be used to modify an audio composition including a plurality of stems. Method 600 is similar to method 200, except that method 600 further includes audio play module 602.

Audio play module 602 may receive an audio composition selection 604. Audio composition selection 604 is an identifier for an audio composition 300 that may be played via audio play module 602. For example, audio play module 602 may play audio composition selection 604 via audio playback speaker 110 in device system 101.

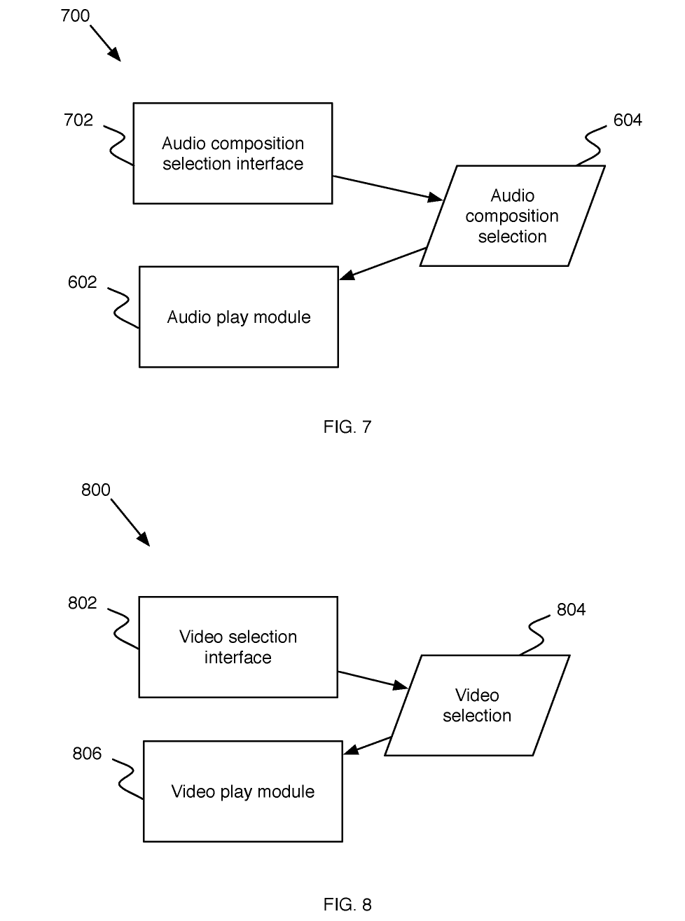

In examples, audio composition selection 604 may be initialized to a default value. In further examples, as depicted in method 700 provided in FIG. 7, audio composition selection 604 may be selected upon displaying an audio composition selection interface 702. Audio composition selection interface 702 may further allow a user to select an audio composition 300 from a library of audio compositions that may be received by audio play module 602. Audio composition 300 may include music, sound effects, dialog, a combination thereof, or any other type of audio commonly known to those of skill in the art.

Audio play module 602 may play each respective stem 302 of audio composition 300 at the respective stem volumes 216 for the first segment 402. Advantageously, this may allow a user to hear the custom audio composition in real time, based upon the values of one or more parameters 206. As a user changes the values of the one or more parameters 206, the user may receive immediate feedback about those changes from audio play module 602, thereby providing an efficient and convenient way to customize an audio composition.

In the example of method 600, audio play module 602 is depicted as being subsequent to stem volume determination module 204. This is not intended to be limiting, however. In examples, audio play module 602 may be included before or after any step included in methods 200 or 600.

In examples, methods 200 and 600 may further include a video play module 806, as depicted in FIG. 8. For example, video module 806 may receive and play a video selection on monitor 108 of device system 101. Video play module 806, when combined with audio play module 602, may play concurrently. This may allow a user to create a custom audio composition to accompany the video selection. Advantageously, the user may create and modify a custom audio composition in real time using the audio play module 602 while watching the video selection play in the video play module 806.

In examples, video selection 804 may be initialized to a default value. In further examples, video selection 804 may be provided by a video selection interface 802. For example, video selection interface 802 may be facilitated via user interface 106 of device system 101.

In embodiments, methods 200 and 600 may include additional steps. For example, methods 200 and 600 may include a parameter selection module 902 depicted in FIG. 9, operable to display and select parameters 206.

In examples, parameter selection module 902 may initialize parameters 206 based on defaults. In further examples, parameter selection module 902 may receive values for parameters 206 based on a software slider 1002, a user input peripheral device 111, a gesture recognition interface 112, a biometric device 114, a sound board device 116, a parameter file, or any other interface, as will be understood by those of skill.

Parameter selection module 902 may display the values of parameters 206. For example, as depicted in FIG. 10, a software slider 1002 may be used to display parameter values along a scale. For example a first software slider 1002 may display a first parameter value along a scale from 0 to 1. A user may adjust first software slider 1002 to change the first parameter value. Methods 200 and 600 may then use the updated first parameter value determined using software slider 1002 to determine respective stem volumes 216 via the stem volume determination module 204.

In examples, software slider 1002 may be implemented on use input peripheral device 111 that includes a touch screen integrated into monitor 108 of device system 101. In further examples, software slider 1002 may be displayed on monitor 108 and manipulated by a user via a non-monitor integrated user input peripheral device 111, such as a mouse, track pad, keyboard, or a separate touch screen.

In the editing and creation of video soundtracks, it is often desirable for a custom audio composition to match the visual and literary events on a video timeline. Conveniently, a user may view the video selection 804 via video play module 806 on monitor 108, while simultaneously adjusting parameters 206 in real time via parameter selection module 902. In this way, a user may match or align the customized audio composition to the events of a video timeline.

As depicted in FIG. 9, when the values of parameters 206 are adjusted or changed, via parameter selection module 902 or any other technique, the parameter selection module 902 may display the newly updated parameter values 206 in real time.

In examples, methods 200 and 600 may include further steps. For example, methods 200 and 600 may include receiving a second value for the parameters for the first segment of the audio composition. The second value for parameters 206 may be received, for example, via parameter selection module 902. Methods 200 and 600 may determine the respective stem volumes 216 for the second value of parameters 206 via the stem volume determination module 204.

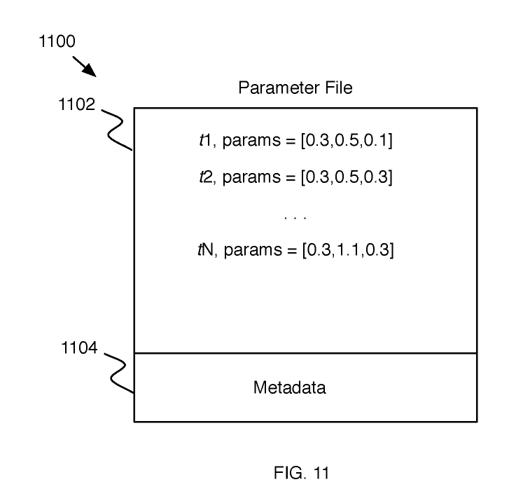

In examples, methods 200 and 600 may include saving the values of parameters 206 to a parameter file 1100, depicted in FIG. 11.

Parameter file 1100 may include a timeline of parameter values 1102 at different times. In examples, parameter file 1100 may record parameter values 206 at regular intervals. In further examples, parameter file 110 may only record parameter values at times when the parameter values change.

In examples, parameter file 1100 may be opened from or saved to memory 104. In examples, parameter file 1100 may further be shared over the internet 120 with further users, for example with device system 121.

Parameter file 1100 may further include metadata 1104. Metadata 1104 may identify the audio composition 504, video selection 604, user's name, video length, and/or a video path, in addition to other settings and data, as will be understood by those of skill in the art.

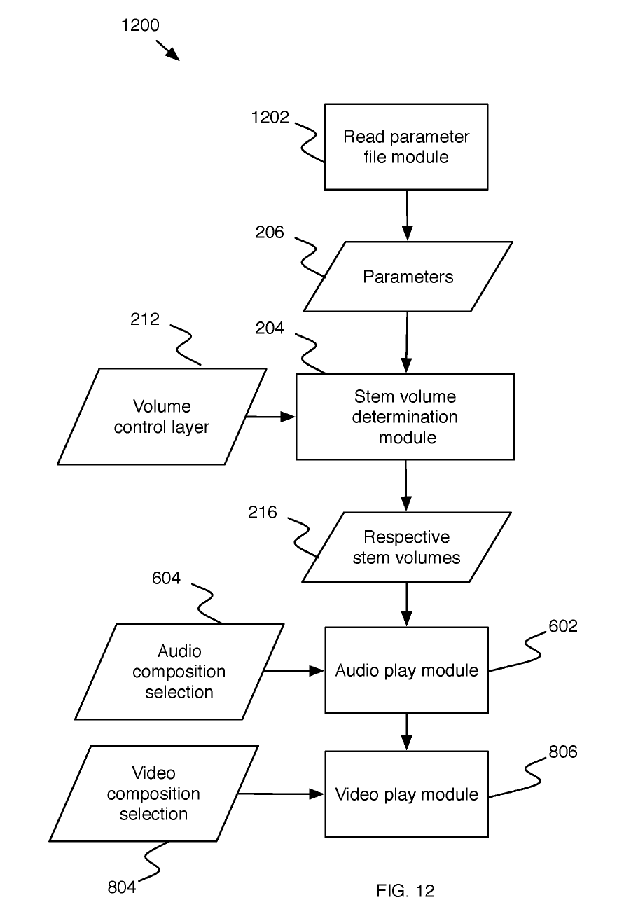

In embodiments, method 600 may include further steps. For example, FIG. 12 depicts method 1200. Method 1200 may be used to play audio composition 300 and video selection 804. Method 1200 is similar to method 600, except that method 1200 further includes audio play module 602 and read parameter file module 1202.

Read parameter file module 1202 may read parameter file 1100 to provide values for parameters 206. The values of parameters 206 from parameter file 1100 may be used with stem volume determination module 204 to determine respective stem volumes 216.

Method 1200 may play the audio composition selection via audio play module 602 and video composition selection 804 via video play module 806, as described above.

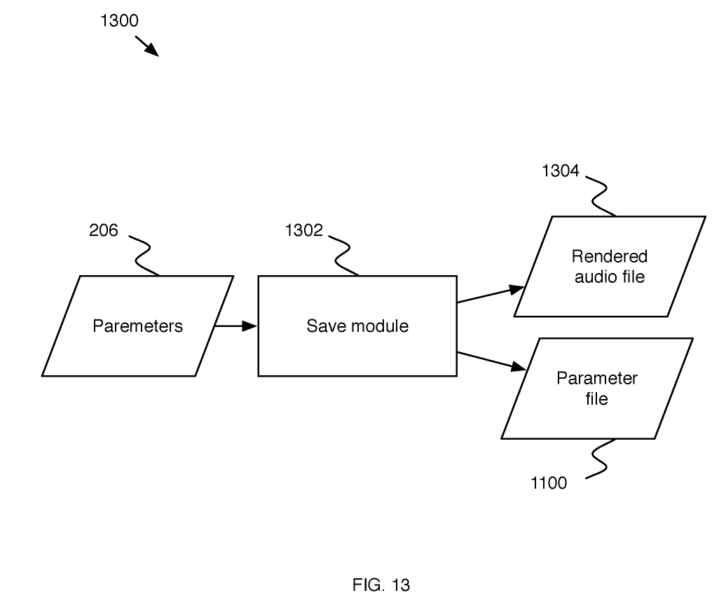

Methods 200, 600, or 1200 may include further steps. For example, methods 200, 600, or 1200 may include a save module 1302, as depicted in FIG. 13. Save module 1302 is operable to receive values for parameter 206 and save those values to parameter file 1100.

Alternatively, save module 1302 may be operable to save a custom audio composition in the form of a rendered audio file 1304. Rendered audio file 1304 may be an audio playback file including the plurality of stems of audio composition 300 played at the respective stem volumes 216.

In examples, save module 1302 may further include the video selection and the custom audio composition into a rendered video file. The rendered video file may be an audio and video playback file including the plurality of stems of audio composition 300 played at the respective stem volumes 216.

Rendered audio file 1304 and the rendered video file may be in any file format commonly known to those of skill in the art, including but not limited to MP3, MP4, or WAV formats.

Advantageously, parameter file 1100 may be relatively small in comparison to a typical audio playback file or an audio composition file. Parameter file 1100 may therefore be easier to port and share with other users. A user with access to a library including audio composition 300 who receives parameter file 1100 may play back the custom audio composition via method 1200.

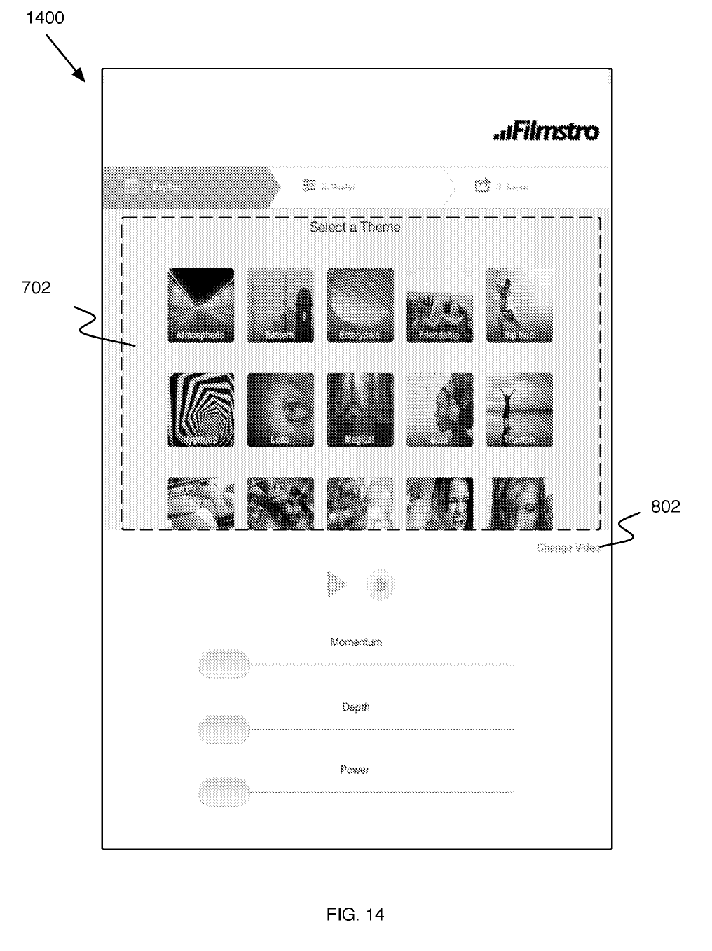

FIG. 14 depicts an example user interface 1400. User interface 1400 includes an example audio composition selection interface 702 and an example video selection interface 802.

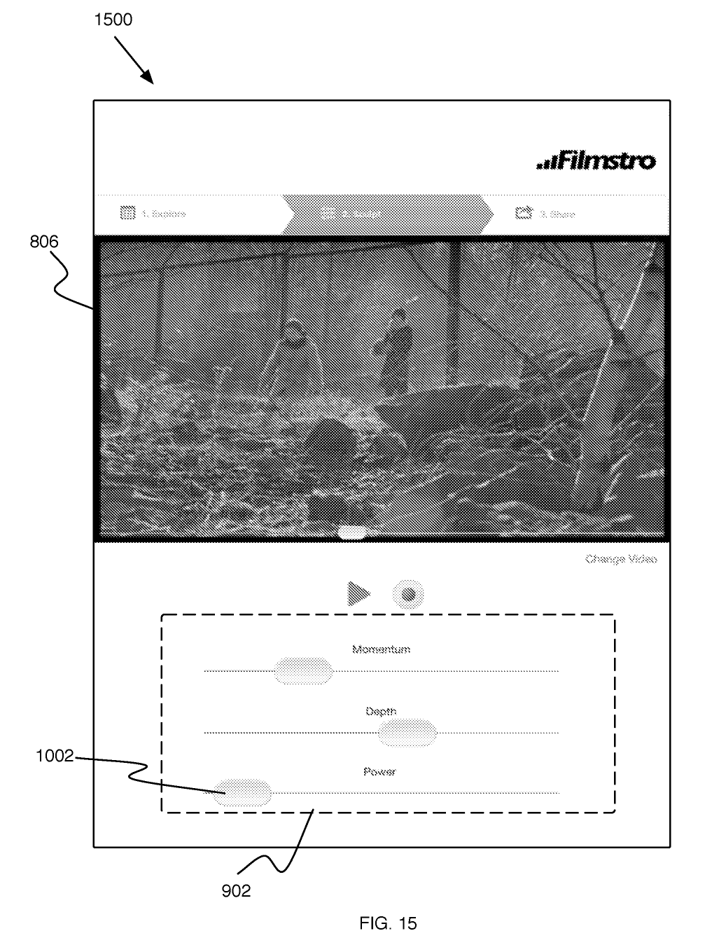

FIG. 15 depicts an example user interface 1500. User interface 1500 includes an example parameter selection module 902, with software sliders 1002. In examples, the software sliders 1002 depicted in user interface 1500 may be manipulated via a user input peripheral device 111 that includes a monitor-integrated touch screen interface.

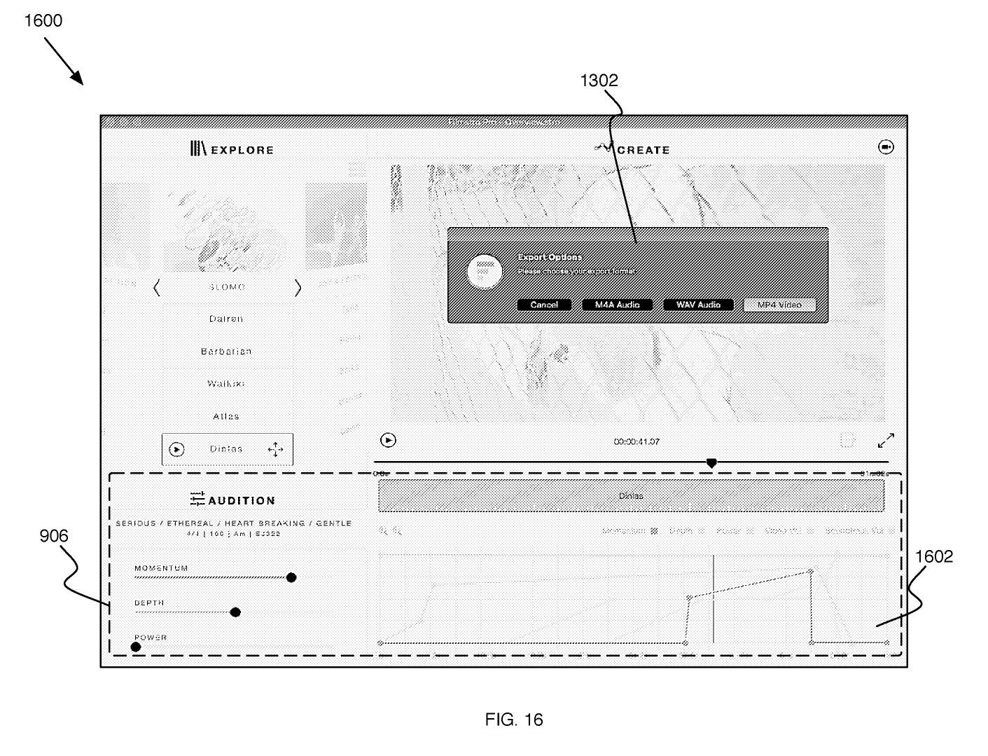

FIG. 16 depicts an example user interface 1600. User interface 1600 includes a further example parameter selection module 902 and an example save module 1302. The parameter selection module 902 included in user interface 1600 includes software sliders 1002, and it further includes a parameter timeline 1602. Conveniently, parameter timeline 1602 provides a set of parameter values over the length of a video so that the user may determine how the parameters change with time. This may help the user to understand how the parameters have been set with regards to specific video events.

In examples, the values of the parameters included in parameter timeline 1602 may be initiated by reading parameter file 1100. As the user changes with software sliders 1002 over one or more segments of an audio composition, the user may then view how the parameters have changed with respect to parameter timeline 1602.

The example save module 1302 included with user interface 1600 allows a user to select the file format that a rendered audio file 1304 will be saved to. Conveniently, this allows a user to create a polished final product that may be played back in any compatible media reader.

A potential advantage of some examples is that it may be possible to create custom audio compositions using a real time interface. The custom audio compositions may be recorded in small files that may be ported to any platform, shared, opened for playback, and further modified.

While the present disclosure has been illustrated by the description of the examples thereof, and while the examples have been described in considerable detail, it is not the intention of the applicant to restrict or in any way limit the scope of the appended claims to such detail. Additional advantages and modifications will readily appear to those skilled in the art. Therefore, the disclosure in its broader aspects is not limited to the specific details, representative apparatus and method, and illustrative examples shown and described. Accordingly, departures may be made from such details without departure from the spirit or scope of applicant's general inventive concept.

1. A method for determining a respective stem volume for each respective stem of an audio composition including a plurality of stems, the method including:
receiving a first value for each of one or more parameters for a first segment of the audio composition; and
for each respective stem of the audio composition, determining a first respective stem volume for the first segment of the audio composition based on the one or more parameters and a volume control layer.

2. A method as claimed in claim 1, further including:
playing each respective stem of the audio composition at the first respective stem volume for the first segment.

3. A method as claimed in claim 1, further comprising:
receiving a second value for each of one or more parameters for a first segment of the audio composition; and
for each respective stem, determining a second respective stem volume for the first segment based upon the one or more parameters and the volume control layer.

4. A method as claimed in claim 1, wherein, for each respective stem of the audio composition, determining a first respective stem volume of the audio composition based on the one or more parameters and a volume control layer further includes:
filtering the volume control layer corresponding to the respective stem using the one or more parameters to identify a filtered volume control layer; and
calculating the first respective stem volume for the respective stem using the one or more parameters and the filtered volume control layer.

5. A method as claimed in claim 1, wherein the volume control layer includes one or more volume keys.

6. A method as claimed in claim 1, wherein calculating the first respective stem volume for the respective stem using the one or more parameters and the filtered volume control layer further includes: performing a linear calculation.

7. A method as claimed in claim 1, wherein calculating the first respective stem volume for the respective stem using the one or more parameters and the filtered volume control layer further includes: performing a non-linear calculation.

8. A method as claimed in claim 1, wherein the volume control layer includes a neural network.

9. A method as claimed in claim 1, wherein the one or more parameters include a momentum parameter.

10. A method as claimed in claim 1, wherein the one or more parameters include a depth parameter.

11. A method as claimed in claim 1, wherein the one or more parameters include a power parameter.

12. A method as claimed in claim 1, wherein the one or more parameters include a time stretching parameter.

13. A method as claimed in claim 1, wherein the one or more parameters include an instrument selection parameter.

14. A method as claimed in claim 1, wherein each respective stem of the set of stems corresponds to a single instrument.

15. A method as claimed in claim 1, further including the step of:
calculating a duration of the first segment based on the one or more parameters.

16-18. (canceled)

19. A method as claimed in claim 1, further including:
saving the one or more parameters and a timestamp for a first segment to a parameter file.

20. A method as claimed in claim 1, further including:
saving a rendered audio file including each respective stem at the first stem volume for the first segment.

21. A method for playing a video and an audio composition including a set of stems, the method including:
determining a respective stem volume for a first segment of the audio composition, each respective stem of the audio composition being determined via a method as claimed in claim 1; and
playing the video and audio composition;
wherein the value for each of one or more parameters is received from a parameter file.

22. A method for modifying an audio composition, including a plurality of stems, the method including:
determining a respective stem volume for a first segment of the audio composition, each respective stem of the audio composition being determined via a method as claimed in claim 1; and
playing the audio composition selection;
wherein the value for each of one or more parameters is received from a parameter selection module.

23. A method as claimed in claim 22, further including:
displaying a parameter selection module, the parameter selection module indicating the values of the one or more parameters.

24-29. (canceled)

30. A system configured to determine a respective stem volume for each respective stem of an audio composition including a plurality of stems via a method as claimed in claim 1.

31. A system configured to play a video and an audio composition including a set of stems via a method as claimed in claim 21.

32. A system configured to modify an audio composition via a method as claimed in claim 22.
